(19) United States
(12) Patent Application Publication
(10) Pub. No.: US 2026/0276361 A1
(43) Pub. Date: Sep. 17, 2026

(54) METHODS AND SYSTEMS FOR MONITORING THE INTEGRITY OF LINERS

(71) Applicant: SAUDI ARABIAN OIL COMPANY, Dhahran (SA)

(72) Inventors: Abderrazak Traidia, Lussan (FR); Thibault Villette, Belfort (FR); Anwar Parvez, Jebel Heights (SA); Abdulaziz Asiri, Dhahran (SA); Isaac Enrique Aguilar Ventura, Mexico City (MX); Sebastien Duval, Dhahran (SA)

(73) Assignee: SAUDI ARABIAN OIL COMPANY, Dhahran (SA)

(21) Appl. No.: 19/076,412

(22) Filed: Mar. 11, 2025

(51) Int. Cl. G01B 5/30

(52) U.S. Cl. CPC G01B 5/30

(57) ABSTRACT

Methods and systems are disclosed herein. A method for monitoring integrity of liners for storing or transporting fluids includes measuring a first initial pressure of a parked fluid within an annulus of a lined unit. The first initial pressure of the parked fluid is measured when a liner of the lined unit is in an undeformed state. The method includes injecting a first volume of an injection gas into the annulus to deform the liner. The method includes measuring a first pressure response from a first start time to a first stop time yielding a first test. The first pressure response includes a first set of one or more pressure measurements measured between the first start time to the first stop time.

### BACKGROUND

Fluid conveyance system units, such as pipes and tanks, may be used to transport or store various types of fluids (e.g., oil, gas, water, chemicals, etc.), some of which may be corrosive fluids. For example, production fluids (e.g., oil and gas) are extracted from hydrocarbon reservoirs using production wells. The production wells are typically connected to gathering systems and/or production plants by pipes. Pipes are typically constructed of steel. Corrosive fluids may corrosively interact with the steel of the pipes. The corrosive interaction with the steel may cause structural weakening and even pipe failure resulting in leaking corrosive fluids into the environment. Fluid conveyance system units, such as pipes, may include a sacrificial liner such as a polymer liner to prevent corrosion of the steel. Liners may exhibit degradation due to various reasons such as erosion, fluid uptake and ageing. There exists a need for monitoring lined fluid conveyance system units and for determining liner degradation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a system for monitoring liners of a lined unit for storing or transporting fluids. The system includes a flow line, a fluid tank, a flow controller disposed on the flow line, a pressure gauge disposed on the flow line, and a deformation modeling system. The flow line is configured to facilitate a fluid flow. The fluid tank configured to inject a first volume of an injection gas through the flow line into an annulus of the lined unit. The flow controller is configured to adjust a flow rate of the injection gas into the annulus. The pressure gauge is configured to measure a first set of one or more pressure measurements within the annulus of the lined unit measured from a first start time to a first stop time. The deformation modeling system is configured to determine a first pressure response based on the first set of one or more pressure measurements from the pressure gauge.

In some aspects, the techniques described herein relate to a method for monitoring lined units for storing or transporting fluids. The method includes measuring a first initial pressure of a parked fluid within an annulus of a lined unit. The first initial pressure of the parked fluid is measured when a liner of the lined unit is in an undeformed state. The method includes injecting a first volume of an injection gas into the annulus to deform the liner. The method includes measuring a first pressure response from a first start time to a first stop time yielding a first test. The first pressure response includes a first set of one or more pressure measurements measured between the first start time to the first stop time.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts components of a system for monitoring lined units in accordance with one or more embodiments.

FIG. 2A depicts components of a system for monitoring lined units in accordance with one or more embodiments.

FIG. 2B depicts components of a system for monitoring lined units in accordance with one or more embodiments.

FIG. 3 depicts a cutaway view of a system unit and a liner used in relation to a system for monitoring lined units in accordance with one or more embodiments.

FIG. 4 depicts an example retention curve result that may be generated by a system for monitoring lined units in relation to one or more embodiments.

FIG. 5 depicts an example representative model for liner degradation generated in relation to one or more embodiments.

FIG. 6 depicts an example pressure response generated by a system for monitoring lined units in relation to one or more embodiments.

FIG. 7 depicts example test results of various inspection tests in relation to one or more embodiments.

FIG. 8 is a flowchart depicting a method for monitoring lined units in accordance with one or more embodiments.

FIG. 9 depicts a computer system that may be used in relation to various embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope of the invention should not be considered limited to the specific arrangement of steps shown in the flowchart.

Although multiply dependent claims are not introduced, it would be apparent to one of ordinary skill that the subject matter of the dependent claims of one or more embodiments may be combined with other dependent claims.

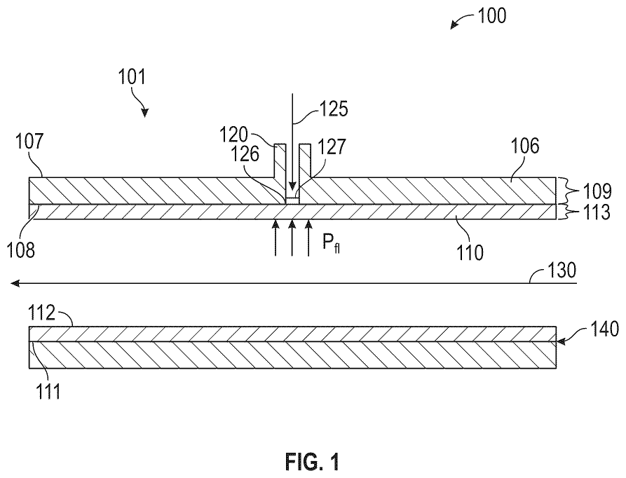

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

For the purposes of the present disclosure, accompanying components that are conventionally used in monitoring and injection gases, such as pumps and compressors, gas handling apparatuses, valves, sensors, electronic controllers, heat exchangers, and mixers, are not shown or discussed for the sake of simplicity, although in an actual operating system these and many more apparatuses and systems would be included. One of ordinary skill in the art appreciates that such components may be included in the embodiments disclosed.

Methods and systems for monitoring integrity of liners are disclosed herein. A system for monitoring integrity of liners of lined units for storing or transporting fluids in accordance with one or more embodiments includes a gas tank, a flow controller, and a pressure gauge. In some embodiments, liners may be disposed in any fluid conveyance system unit (hereafter “system unit”) to form a lined unit, such as in a tubular member to form a lined pipe or in a tank to form a lined tank. Liners may also be disposed in any other fluid conveyance system unit such as tubing, hoses, pumps, fittings, connectors, and the like. Each lined unit includes the system unit and a liner disposed within the system unit. A system unit includes a unit outer surface and a unit inner surface with a unit wall disposed therebetween. The liner includes a liner inner surface and a liner outer surface. An annulus is formed between the unit inner surface and the liner outer surface. An inlet port having a port inner flow path formed axially throughout may be disposed on the system unit. The inlet port is formed radially through the unit wall, extending from the unit outer surface to the unit inner surface. A first end of the port inner flow path abuts the liner outer surface. The gas tank is fluidly connected to the inlet port by a flow line and is configured to inject a volume of injection gas through the port inner flow path into the annulus. The flow controller is disposed on the flow line and configured to adjust a flow rate of the injection gas. The pressure gauge is disposed on the flow line and configured to measure a pressure of the injection gas.

Embodiments disclosed herein generally relate to a non-destructive and non-intrusive method for assessing and/or monitoring an integrity of liners used in lining system units such as polymer liners used in polymer-lined pipe applications. More specifically, embodiments herein provide an annulus testing method where an injection gas, such as an inert gas, is injected in the annulus between the liner and the system unit at a flow rate that may be constant and where the pressure build-up in the annulus is monitored over time during a testing period. A mathematical model based on simple beam theory and annulus pressure build-up kinetics is used as an indication of liner degradation that may be due to a number of factors such as ageing and reduction in tensile modulus (e.g., Youngs's modulus) of the liner material such as polymers and/or a reduction in liner thickness.

FIG. 1 depicts a lined unit (101) and components of a liner monitoring system (100) in accordance with one or more embodiments. A lined unit, such as the lined unit (101), includes a system unit (106) and a liner (110). Each lined unit may be used for storing or transporting fluids. For example, the lined unit (101) may be a lined pipe. A lined pipe includes one or more tubular members and the liner (110). The system unit (106) includes a unit outer surface (107) and a unit inner surface (108) with a unit wall (109) therebetween. The system unit (106) also includes a production flow path (130) formed axially throughout. In some embodiments, the system unit (106) may be an existing system unit or a newly constructed system unit. A system unit may be a pipe, tank, tubing, hose, container, and the like, and is configured to transport or store a fluid. Even though only one system unit and liner in FIG. 1 are shown, it will be apparent that more than one lined unit, each having a system unit, and a liner may be included without departing from the scope of the present disclosure. Even though FIG. 1 shows a lined pipe, it will be apparent to those skilled in the art that the liner monitoring system may be used to monitor liners disposed in any system unit configured to receive a liner and that the illustrated tubular member may be various system units such as a tank configured to store a fluid and the particular tubular member shown should not be considered limiting.

In accordance with one or more embodiments, the system unit (106) may be fluidly connected to various systems and infrastructure configured to handle fluids including corrosive fluids (e.g., hydrocarbons, and contaminated water). For example, the system unit (106), such as a tubular member, may be fluidly connected to a production well configured to extract hydrocarbons from a hydrocarbon reservoir and flow the hydrocarbons to a gather system or a production plant for processing via the system unit (106). In other embodiments, the system unit may be a container configured to store the hydrocarbons within the production plant. The production well, the gathering system, and/or the production plant may be any hydrocarbon well, gathering system and/or hydrocarbon production plant known to those skilled in the art.

System units, such as tubular members, according to embodiments disclosed herein may be constructed of any material, such as steel, suitable for transporting fluids. The system unit (106) is configured to transport fluids along the production flow path (130). The system unit (106) is configured to withstand a fluid pressure (Pa) exerted on an inner surface of the system unit (106) by the transportation of the fluid through the system unit (106). The thickness of the system unit (106) may depend upon the desired pressure rating, the composition of the system unit (106), and the system unit's mechanical properties. The inner diameter of the system unit may be based on the amount of fluid necessary to transport and determined by any means known to those skilled in the art. The inner diameter of the system unit (106) may be determined based on the outer diameter of the liner (110) as described below.

In one or more embodiments, the system unit (106), such as a tubular member, may include a connection system at either end along the axial direction configured to connect to another tubular member or other various system units. The connection system may include a flange disposed on each end of the system unit (106). The flange may include a plurality of fastening holes configured to receive fasteners such as nut and bolt sets to facilitate the connection of system units together. The connection system may have sufficient strength in the axial direction to transfer loads from one system unit to the other.

The liner (110) includes a liner outer surface (111) and a liner inner surface (112) with a liner wall therebetween having a liner thickness (113). The liner thickness (113) may be consistent throughout the length of the liner (110). In some embodiments, the liner (110) is disposed radially along the unit inner surface (108). The liner inner wall forms an outer bound of the production flow path (130) during use. Due to the concentric relationship between the liner (110) and the system unit (106), an annulus (140) is formed between the unit inner surface (108) and the liner outer surface (111).

Liners according to embodiments disclosed herein may be formed from any material suitable for providing protection from corrosive fluids, and may be formed from materials such as natural or synthetic rubbers or other man-made polymers as known in the art. Polymer material may include thermoplastic polymer. The polymers used to form the liners may be selected based on the properties of the material to be conveyed or handled according to embodiments herein. In some embodiments, liners useful in embodiments herein may be formed from polyethylenes such as ultra-high molecular weight polyethylene (UHMWPE), high density polyethylene (HDPE), or medium density polyethylene (MDPE), or from other materials such as polyethylene of raised temperature (PE-RT), polyvinylidene fluoride (PVDF), polyamide (PA), polyphenylene sulfide (PPS), or polyketone (POK), among others known in the art.

Liners according to embodiments disclosed herein may be formed from a thermoplastic through any means known to those skilled in the art. These may include, but are not limited to, extrusion or pultrusion. In one or more embodiments, the liner (110) may be extruded to a target liner thickness and diameter. Extrusion may produce any thickness needed for the liner (110). In some embodiments, the molten thermoplastic may be pulled by a puller after exiting a cylindrical die prior to being cooled and solidified. The liner outer diameter may be determined based on the inner diameter of the system unit, such as the system unit (106) as described above and determined by any means known to those skilled in the art. The thickness of the internal liner may depend upon the desired pressure rating, the composition of the liner, the liner properties, intended fluid transported, projected service life, and other factors known to one skilled in the art.

Liners according to embodiments disclosed herein may include liner materials (e.g., thermoplastic polymer) having a viscoelasticity, i.e., their behavior and properties are not only dependent on temperature but also on the rate of change in external solicitations/loads. Liners according to embodiments disclosed herein may include a liner structural integrity that may be related to the thickness of the liner (110) and one or more mechanical properties (e.g., tensile modulus, bulk modulus, shear modulus, and the like) of the liner material. Monitoring the alteration in mechanical properties of the liner material (particularly modulus) is important to prevent damage mechanisms such as, but is not limited to, liner collapse under rapid gas decompression (RGD).

For example, a tensile modulus, E, also referred to as the modulus of longitudinal elasticity and Young's modulus, describes the resistance of a material (e.g., liner material) to stretching or compression during elastic deformation. The modulus of elasticity is a set of physical quantities that characterize the ability of any solid body to be elastically deformed under conditions where force is applied to it. That is, the Young's modulus may be defined as the ratio of uniaxial tensile/compressive stress on a material to the resulting extensional/compressional strain of the material and may be measured in gigapascals (GPa).

Liners according to embodiments disclosed herein may experience liner degradation and ageing of a physical nature such as swelling as a result of fluid uptake (e.g., aromatic hydrocarbons in polyolefins). Fluid uptake induces a plasticization of polymer matrix of the liner (110) and therefore reduction of mechanical properties (e.g., tensile modulus) of the liner (110). Swelling and plasticization are generally fully reversible upon full desorption of the permeated fluids. In other words, the original mechanical properties can be fully recovered upon desorption. The ageing process may alter the liner material's mechanical properties. Liner thickness may decrease in one or more small local areas around the liner (110) due to one or more degradation processes such as ageing. A decrease in the liner thickness (113), even in small local areas, may compromise the structural integrity of the liner leading to liner collapse. A small local area may refer to any surface area smaller than the surface area of the entire liner.

Liners according to embodiments disclosed herein may experience liner degradation and ageing of a chemical nature. Ageing may occur as a result of a chemical degradation reaction (e.g., hydrolysis) between the absorbed fluids and the polymer material of the liner (110). Chemical degradation may result in a permanent degradation of mechanical properties such as polymer brittleness and loss of ductility.

The liner (110) may be spooled on a reel after being extruded for storage before subsequent steps in the pipe manufacturing process. In other embodiments, the liner (110) may be disposed in the system unit (106), such as the tubular member, directly, without an intermediate spooling step.

The liner (110) may be used in rehabilitation of existing system units such as steel pipes used to transport corrosive fluids. In some embodiments, the liner (110) may be disposed in the system unit (106) during construction process of the system unit. For example, the tubular member and the liner (110) form lined pipes such as polymer-lined pipes (PLP″).

In accordance with one or more embodiments, the liner (110) may be pulled into the system unit (106) using a puller (not shown). The liner (110) may provide a barrier to the direct contact of fluids with the system unit, such as a metallic pipe, thus preventing or limiting any corrosion degradation of the system unit. Different installation techniques are available in the market, but in general tight fit solutions are preferred to minimize parked fluid build-up in the annulus (140) between the liner (110) and the system unit. Such pressure build-up is generally responsible for possible liner collapse upon rapid depressurization. Tight fit installation techniques rely on the basic principle of reducing the liner diameter (through axial pulling and radial compression) before pulling the liner (110) into the steel pipe, and upon releasing the pulling forces, the relaxation of the liner (spring back effect) will ensure tight fit to the host steel pipe.

For rehabilitation of existing system units, such as pipelines formed from one or more tubular members, there is a limitation on the maximum length of the liner (110) that can be pulled into the system unit (106) (referred to as a pull length), for example, pull lengths may range from a few meters for tanks to 800 m for pipelines that include pipe-to-pipe connectors (e.g., flanges) needed for lining long length pipelines. For example, each lined pipe may include, but is not limited to, tubular member lengths of 20, 30, or 40 feet that are operatively connected to form the pipeline. The pull length of the liner may depend on liner thickness, liner material and properties such as elasticity/deformability so as to accommodate insertion and placement procedures within the tubular member as well as other factor readily recognized by a person having ordinary skill in the art.

For a liner material (e.g., polyethylene or nylon as typical materials), the liner mechanical and geometrical properties may be used to determine the liner length and other design determinations such as the liner thickness (113), outer diameter of the liner (110), and the like. The liner thickness (113) may be configured to provide resistance against specific load cases and functional requirements such as the liner thickness (113) based on pulling loads, liner collapse (RGD), diameter reduction (swaging), and permeation resistance.

The liner monitoring system (100) includes one or more inlet ports (120) connectable to one or more flow lines, or to other means for injecting an injection gas into the annular space between the liner (110) and the system unit (106). The one or more inlet ports (120) may be disposed along the length of the system unit (106) or at either end of the system unit (106). The inlet port (120) includes a port inner flow path (125) formed axially throughout. The inlet port (120) is configured to transport a gas such as an injection gas (201). The inlet port (120) is formed radially through the unit wall (109), extending from the unit outer surface (107) to the unit inner surface (108). The inlet port (120) includes a first end (126) of the port inner flow path (125) that abuts the liner outer surface (111). The inlet port (120) may be constructed of any material suitable for injection of injection gas into the annulus (140) such as steel, or polymer. The wall thickness of the inlet port (120) may depend upon the desired pressure rating for injecting gas through the inlet port (120), the composition of the inlet port (120), and other factors known to one skilled in the art. For example, the inner diameter of the inlet port (120) may be based on the amount of injection gas necessary to be injected over a given time, while minimally interacting with the liner during normal operation/fluid transport.

In accordance with one or more embodiments, the inlet port (120) may be disposed on an existing system unit or may be constructed when the system unit (106) is newly constructed. The system unit (106) may include an inlet hole coupled with the inlet port (120) to form the port inner flow path (125). The inlet port (120) is formed radially through the unit wall (109). The inlet hole may be machined by any process known to those skilled in the art such as drilling, or boring. The inlet hole may be located on the system unit (106) in any location suitable for injecting gas. The location of the inlet port (120) may be disposed around the periphery of the inlet hole. The inlet port (120) may be bonded to the system unit (106) by any process known to those skilled in the art such as welding and/or adhesives. Even though FIG. 1 shows only one inlet port, it will be apparent to those skilled in the art that there may be more than one inlet port disposed on the system unit (106).

In some embodiments, the inlet port (120) may include a screen (127) configured to allow fluids such as the injection gas to pass through the screen (127) and to prevent a liner such as the liner (110) from extruding into the port inner flow path (125) due to the fluid pressure (Pa) as monitoring integrity of a liner, such as the liner (110), may be done while the lined unit is in operation (i.e., P_{fl}>0) or in shutdown periods (i.e., P_{fl}=0). The screen (127) may be arranged to be substantially perpendicular to the port inner flow path (125). The screen (127) may include a mesh constructed from any suitable material such as metal, and/or polymer. The mesh may be connected to an outer ring to hold the mesh in place. The screen (127) may be disposed within the inlet port (120) and held in place by friction between the outer ring and an inner wall of the inlet port (120). The screen (127) may also be connected to the inner wall of the inlet port (120) by welding, brazing, sintering, soldering, or other processes known to those skilled in the art.

While FIG. 1 shows various configurations of components, other configurations may be used without departing from the scope of the disclosure. For example, various components in FIG. 1 may be combined to create a single component. As another example, the functionality performed by a single component may be performed by two or more components.

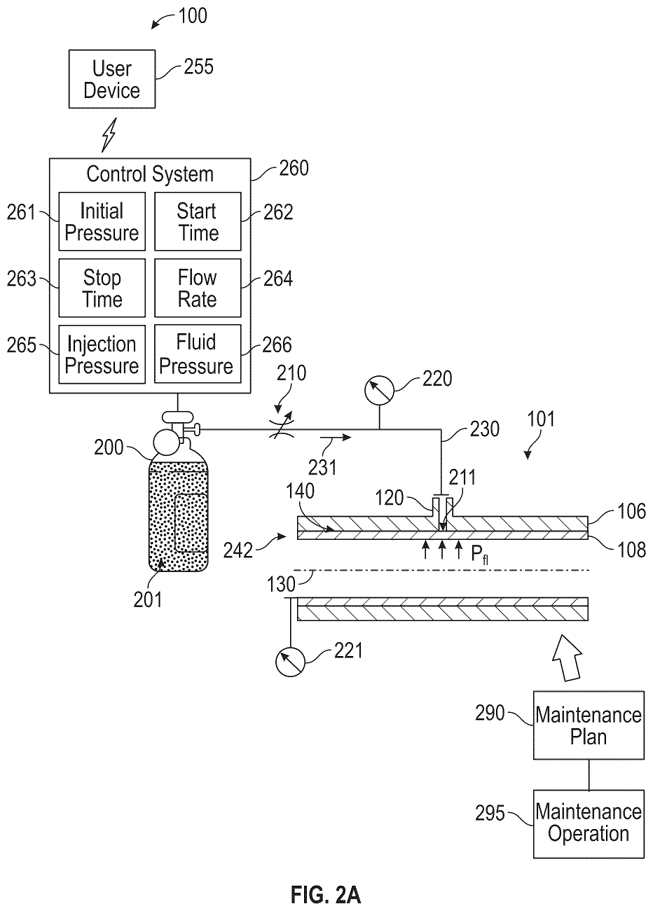

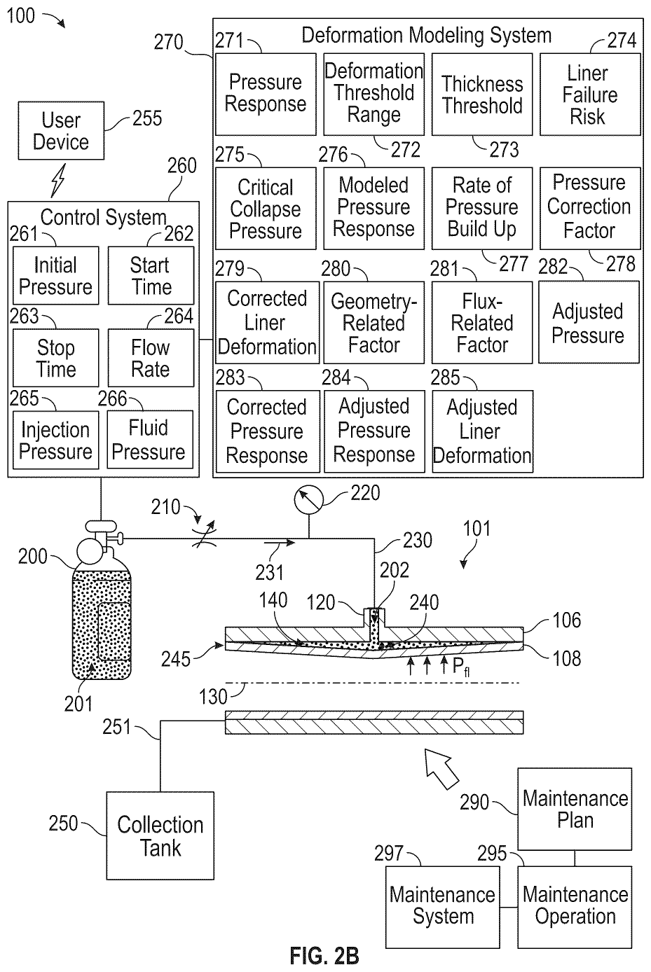

FIG. 2A depicts the liner monitoring system (100) in accordance with one or more embodiments. The liner monitoring system (100) includes a gas tank (200) fluidly connected to the inlet port (120) by a flow line (230) configured to facilitate a gas flow (231) from the gas tank (200) along the flow line (230) to the inlet port (120). The flow line (230) is fluidly connected to the gas tank (200) and the inlet port (120). The gas tank (200) is configured to inject the injection gas (201) through the port inner flow path (125) into the annulus (140). The injection may have a start time (262) and a stop time (263). The injection gas (201) may be any inert gas that would resist reacting with the system unit (106), the liner (110), and/or the inlet port (120), as well as any fluid accumulated in the annular region. The injection gas may include, for example, nitrogen, carbon dioxide, argon or other inert gases known to those skilled in the art. The gas tank (200) is configured to store the injection gas (201) within the gas tank (200). The gas tank (200) is configured to inject gas, the system monitoring the injection pressure (265) of the injected gas. The gas tank (200) may include hardware configured to facilitate the gas flow (231) of the injection gas (201) into the flow line (230) such as fittings, regulators, gas valves, and/or gas pumps that are operatively connected to the gas tank (200) and the flow line (230).

In some embodiments, the liner (110) may be in an undeformed state (242), as shown in FIG. 2A, at the start of a test according to embodiments herein to determine the condition of the liner. In some embodiments, an initial pressure (261) within the annulus may be approximately zero. In some embodiments, the initial pressure (261) may be non-zero. Parked fluid (211) may be present in the annulus (140) resulting in the initial pressure (261) being non-zero. The parked fluid (211) may be gas that has remained since formation of the lined unit or may be gas or oil that has built-up during production operations. The parked fluid (211) may include gas or oil that has infiltrated the annulus (140) by either permeating through the liner (110) from the production flow path (130) or through seams and/or edges of the liner (110) that may not be sealed. In some embodiments, the liner (110) may be undeformed by the parked fluid (211) if a volume of the parked fluid (211) is insufficient to deform the liner (110). In some embodiments, the liner (110) may be deformed by the parked fluid (211) if a volume of the parked fluid (211) is sufficient to deform the liner (110).

In accordance with one or more embodiments, the liner monitoring system (100) includes a flow controller (210) disposed on the flow line (230) and configured to adjust a flow rate (264) of the injection gas (201). In some embodiments, the flow controller (210) may be configured to adjust the flow rate (264) of the injection gas (201) to a constant flow rate. In some embodiments, the flow controller (210) is configured to adjust the flow rate (264) of the injection gas (201) to a sinusoidal flow rate. The sinusoidal flow rate may include varying the magnitude of the flow rate. In some embodiments, the flow controller (210) may be configured to adjust the flow rate (264) of the injection gas (201) to a sweep flow rate. The sweep flow rate may include varying the flow rate in both magnitude and frequency of adjusting the flow rate. It will be apparent to a person having ordinary skill in the art that flow rate range may vary depending on various parameters such as, but not limited to, a liner's material properties, a lined unit diameter, and the test pressure needed to reach maximum liner deformation.

In accordance with one or more embodiments, the liner monitoring system (100) may include one or more pressure sensing devices such as pressure gauges (e.g., a first pressure gauge (220) and/or a second pressure gauge (221)). For example, the pressure sensing devices may be configured to measure one or more sets of one or more pressure measurements continuously (e.g., an analog gauge) or may take one or sets of one or more pressure measurements periodically (e.g., a digital gauge). Pressure measurements may include the pressure of any parked fluids (i.e., an initial pressure (261)) and/or the injected gas (i.e., injection pressure (265)). In some embodiments, the first pressure gauge (220) may be disposed on the flow line (130) and configured to measure pressures (e.g., the initial pressure (261) and/or the injection pressure (265)) within the flow line (130) and/or the annulus (140). In some embodiments, the second pressure gauge (221) may be operatively connected to the lined unit (101) and configured to measure a fluid pressure (266), Pa, of a production fluid within the production flow path (130) of the lined unit (101). A pressure response (271) (e.g., a first pressure response and/or a second pressure response) includes a set (e.g., a first set and/or a second set) of one or more pressure measurements (e.g., the initial pressure (261) and/or the injection pressure (265)) measured between the start time (262) to the stop time (263). The pressure response (271) may be based on a pressure from the parked fluids (211), the injection gas (201), the production fluid, or a combination thereof. The one or more sets of the one or more pressure measurements may be measured by one of the pressure sensing devices (e.g., the first pressure gauge) disposed on the flow line (230) or operatively connected to lined unit. The pressure response (271) may be adjusted based on the one or more measurements from another of the pressure sensing devices configured to measure the fluid pressure (266) to yield an adjusted set of one or more pressure measurements (282).

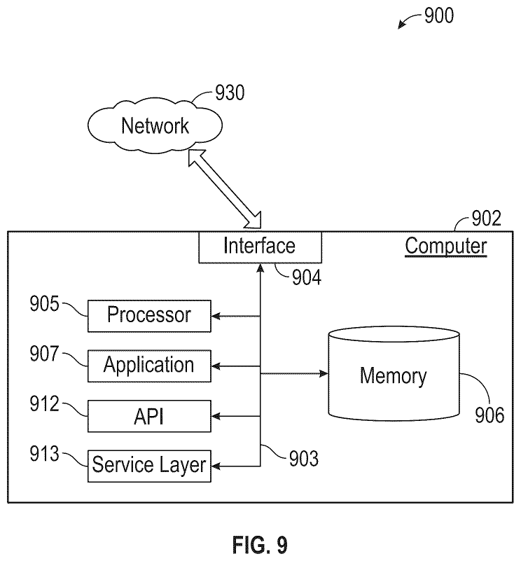

In accordance with one or more embodiments, the liner monitoring system (100) may include a control system (260). In some embodiments, the control system (260) may be a production plant server. In some embodiments, the control system (260) includes a computer system that is the same as or similar to that of computer system (900) described below in FIG. 9 and the accompanying description. In some embodiments, various types of liner monitoring data (e.g., a pressure, a time of operations, a flow rate, etc.) are collected by the liner monitoring system (100) over the course of a test. In some embodiments, the control system (260) may be configured to determine the initial pressure (261) of the parked fluids and/or the injection pressure (265) of the injected gas at any particular time during injection yielding a measured pressure at the time of measurement.

With respect to control systems according to embodiments disclosed herein, a control system may include hardware and/or software that monitors and/or operates equipment of the liner monitoring system (100). In particular, a control system may include a programmable logic controller that may control valve states, fluid levels, pipe pressures, warning alarms, pressure releases and/or various hardware components for monitoring a lined unit. Thus, a programmable logic controller may be a ruggedized computer system with functionality to withstand vibrations, extreme temperatures, wet conditions, and/or dusty conditions, such as those around a pipeline, a hydrocarbon processing plant, hydrocarbon well, and/or a gathering system.

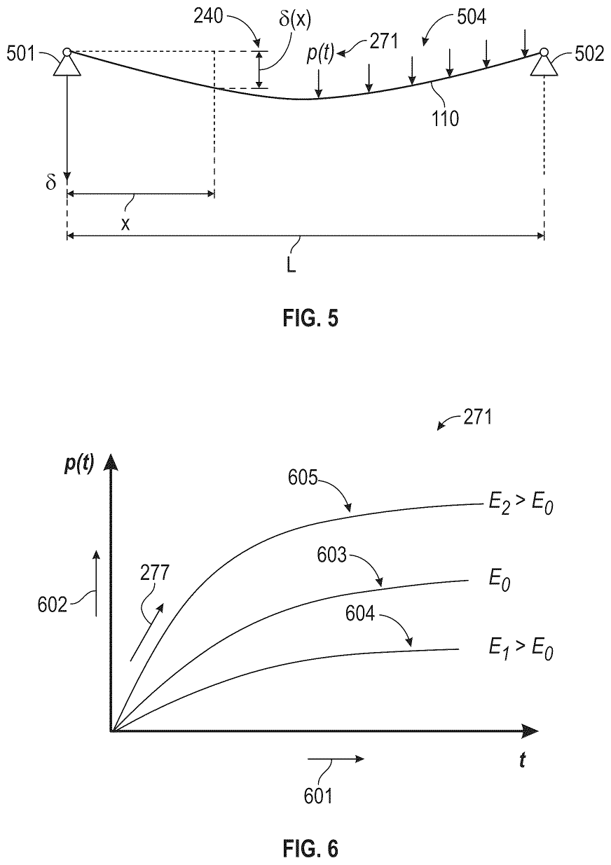

In some embodiments, the control system (260) may include hardware and/or software for collecting liner monitoring data in real-time from various components of the liner monitoring system (100) such as gauges, sensors, controllers, and/or user devices. For example, the control system (260) may be one or more production plant servers with functionality for obtaining data throughout the liner monitoring system (100), such as pressure data (e.g., a first initial pressure and a second initial pressure), start times (e.g., a first start time and/or a second start time) and stop times (e.g., a first stop time and/or a second stop time) of injection operations, and/or flow rates of the injection gas (201). The control system (260) may also be configured to set, from a user, input, such as one or more thresholds (e.g., a deformation threshold range and a thickness threshold). The user input may be received through a user device (255) communicably coupled to the control system (260). The user device (255) may be any device configured to receive user input such as a laptop, smart phone, and/or tablet device. A deformation threshold range may be determined based on modeling of a pressure response curve as described in relation to FIG. 5.

FIG. 2B depicts the liner monitoring system (100) in accordance with one or more embodiments. For brevity and ease of reading, description of similar or the same components will not be repeated. During a test to determine liner integrity, the liner (110) achieves a deformed state (245). The liner (110) may be deformed by a volume of injection gas (202) that is injected into the annulus (140) by the gas tank (200). The liner (110) may be deformed initially around the periphery of the inlet port (120) but may be deformed radially around the annulus (140) as the volume of injection gas (202) is continually injected into the annulus (140). The liner monitoring system (100) is configured to measure a pressure response (e.g., a first pressure response and a second pressure response) during one or more tests.

In some embodiments, the liner monitoring system (100) may include a deformation modeling system (270) configured to determine one or more parameters such as the one or more pressure responses (271) (e.g., a first pressure response and/or a second pressure response) as described in relation to FIG. 6 based on the one or more sets of pressure measurements from the first pressure gauge (220).

In some embodiments, the deformation modeling system is configured to calculate a liner deformation (240) (e.g., a first liner deformation and a second liner deformation) as described in relation to FIG. 5. The liner deformation (240), 6, may be determined from the start time (262) (e.g., a first start time and/or a second start time) to the stop time (263) (e.g., a first stop time and/or a second stop time). The deformation modeling system (270) is further configured to compare the pressure response (271) and/or the liner deformation (240) to an integrity threshold range and/or a deformation threshold range (272), respectively. The deformation modeling system (270) is further configured to determine a liner failure risk (274) based on whether the pressure response (271) and/or liner deformation (240) is outside of the integrity threshold range and/or the deformation threshold range (272), respectively. The deformation modeling system (270) is further configured to determine a maintenance plan (290) based on the liner failure risk (274). A maintenance system (297) may be configured to execute a maintenance operation (295) based on the maintenance plan (290). The maintenance system (297) may include a puller configured to remove an aged liner and to install a new liner disposed within the system unit (106). The maintenance system (297) may include a maintenance vehicle and maintenance devices known to those skilled in the art.

In some embodiments, the deformation modeling system (270) may be configured to compare the liner thickness (113) to a thickness threshold (273) yielding a thickness comparison. The deformation modeling system (270) may be configured to determine the liner failure risk (274) based on the thickness comparison. The deformation modeling system (270) may be configured to determine the maintenance plan (290) based on the liner thickness (113). The deformation modeling system (270) may be configured to initiate the maintenance operation (295) based on the maintenance plan (290). In some embodiments, the deformation modeling system (270) may be configured to model a pressure response yielding a modeled pressure response (276). The modeled pressure response (276) may be compared to a pressure response such as the pressure response (271) to determine the liner failure risk (274).

In embodiments with production flow, the deformation modeling system (270) may be configured to adjust the first set of one or more pressure measurements within the annulus based on the pressure of the fluid to provide an adjusted set of one or more pressure measurements. The deformation modeling system (270) may be configured to determine the first pressure response based on an adjusted set of one or more pressure measurements.

In some embodiments, the deformation modeling system (270) may include a computer system, such as computer system (900) described in relation to FIG. 9. The deformation modeling system (270) will typically be configured with appropriate data processing and analysis software and augmented with a number of purpose specific units, such as high-capacity tape drives or hard drives connected through high-speed buses to computer processing units (“CPUs”). Based upon the disclosure provided herein, one of ordinary skill in the art will appreciate that the gathering of data involves specialized tools to obtain the vast quantities of gathered data, and high-speed processing capability capable of performing at least one thousand calculations per second. Indeed, in some embodiments, processors capable of millions, billions, or even more calculations per second are used.

The deformation modeling system (270) may be communicably coupled to the control system (260) and various components of the liner monitoring system (100) so as to receive data and information so as to calculate various parameters (e.g., liner deformation, liner failure risk, rate of pressure build-up, modeled pressure response, liner thickness) automatically. For example, the deformation modeling system (270) may be configured to determine a geometry-related factor and/or a modeled pressure response. The deformation modeling system (270) may be configured to compare the modeled pressure response to the pressure response.

In some embodiments, the liner monitoring system (100) may include a collection tank (250). The collection tank (250) may be fluidly connected to the annulus (140) via a vent hose (251). The collection tank (250) may be configured to collect at least a portion of the volume of injection gas (202) and/or the parked fluid (211) from the annulus (140). In some embodiments, where the system unit (106) is buried within the subsurface, the vent hose (251) may be a braided stainless steel vent hose configured to resist corrosive interaction with the subsurface such as soil, groundwater, microbes, and the like. The liner monitoring system (100) may include a pump (not shown) operatively connected to the vent hose (251). Collection of the injection gas (201) and/or the parked fluid (211) may include pumping the injection gas (201) and/or the parked fluid (211) out of the annulus (140).

The liner monitoring system (100) provides monitoring of various liner properties such as the liner thickness (113) to mitigate risk from liner failure, such as liner collapse. To mitigate against liner collapse, the liner thickness (113) must be sufficiently thick to ensure that a maximum annulus pressure Pₘ (i.e., bore pressure at steady state) is kept below a critical collapse pressure (275), P_{c}. Potential for liner collapse may be determined as a 2-D plane strain problem and the critical collapse pressure (275), P_{c}, may be expressed as:

$${p}_{c} = A \frac{E}{( 1 - {v}^{2} )} {( \frac{h}{R} )}^{n} , \qquad ( 1 )$$

where A and n are constants that depend on external restraints on the liner (110), E is the Young's modulus, v is the Poisson ratio and his the thickness of the liner (110), and R is a radius of the liner (110). A liner failure risk (274) may be reduced with increased liner thickness (113), h, and increase of the Young's modulus, E The injection pressure (265) may include a measured pressure of the injection gas (201) in a range having a lower limit of a pressure associated with elastic deformation of the liner (110) and having an upper limit of a pressure associated with the critical collapse pressure (275) of the liner (110). The lower limit of a pressure associated with elastic deformation may include a minimum pressure where elastic deformation of the liner (110) may begin. The liner thickness (113) may degrade over time with ageing of the liner (110).

While FIG. 2A-2B shows various configurations of components, other configurations may be used without departing from the scope of the disclosure. For example, various components in FIG. 2A and/or FIG. 2B may be combined to create a single component. As another example, the functionality performed by a single component may be performed by two or more components.

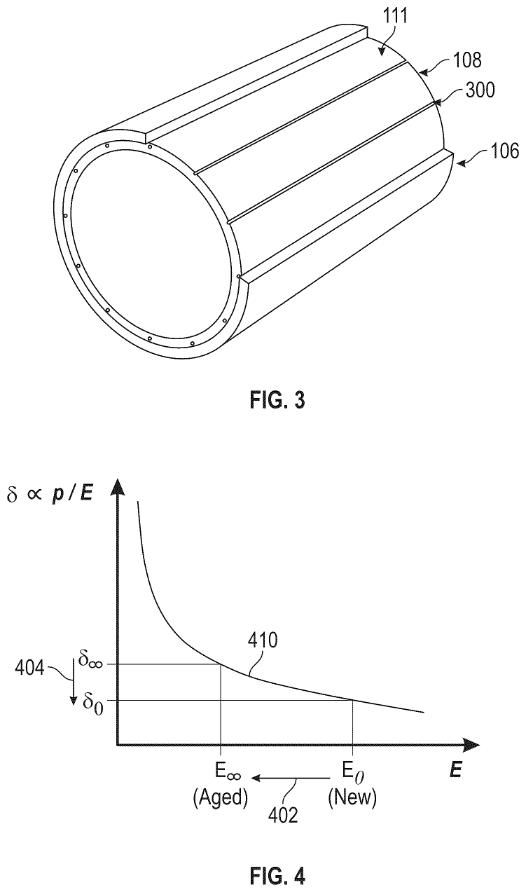

FIG. 3 depicts a cutaway view of components of the lined unit (101) in accordance with one or more embodiments. In some embodiments, the liner (110) may include the liner outer surface (111) that is smooth. In some embodiments, the liner outer surface (111) may include a non-smooth liner outer surface. For example, the liner outer surface (111) may include one or more grooves (300). The one or more grooves (300) may be spaced periodically around the liner outer surface (111). In some embodiments, the one or more grooves (300) may be formed longitudinally along a length of the liner outer surface (111). Each groove (300) is configured to provide fluid (e.g., parked fluids and/or injection gas) venting and prevent liner collapse.

FIG. 4 depicts an example retention curve (410) generated by the liner monitoring system (100) in accordance with one or more embodiments. An X-axis (402) represents the Young's modulus of an ageing liner, and a Y-axis (404) represents elastic deformation of an ageing liner. The injection gas (201) may be injected at a constant flow rate which can be set using the flow controller (210). The resulting pressure in the annulus (140), p, is monitored over time. Careful considerations must be taken to ensure that pressure (i.e., net pressure between pressure in the annulus and fluid pressure in the system unit), p, stays far away from the critical collapse pressure (275), p_{c}, of the liner (110), yet sufficiently high to cause small (elastic) reversible deformation, δ, of the liner (110) near the inlet port (120).

A retention curve such as the example retention curve (410) may be formed at a specific pressure. Using liner material that is linear elastic (i.e., liner deformation is not permanent) within a pressure range, a maximum deformation, δ, may be proportional to the ratio p/E (where E is the Young's modulus of the liner material). Any alteration in time (e.g., due to ageing) of the Young's modulus, E, of the liner (110) may translate in change of the maximum deformation, δ, as shown in FIG. 4. The change in maximum deformation and corresponding pressure response may be used to monitor the degradation of the liner material. The monitoring of the liner (110) may be provided by comparing an inspection test of a liner in service (e.g., aged, δ∞) against a first test of the same liner material at the same location when newly installed (e.g., unaged, δ₀). Test conditions between tests should be considered and taken into account when testing. Test conditions should be consistent so that test results are comparable. Test conditions include, but are not limited to, fluid pressures within the system unit and environmental conditions (temperatures, atmospheric pressures, and the like).

In accordance with one or more embodiments, a test (e.g., a first test, and/or an inspection test) includes injecting the injection gas (201) into the annulus (140) thereby increasing the annulus pressure and volume (at least around the inlet port (120)). A steady state may be reached when a maximum annulus volume is reached, and the annulus may not accept any additional volume of injection gas. In some embodiments, a steady state may be reached when a maximum annulus volume is reached and any additional volume of injection gas injected into the annulus (140) is equivalent to any volume of fluids within the annulus (140) (e.g., injection gas and/or parked fluid) that is vented. Therefore, any change in pressure, p, is proportional to an alteration in maximum deformation, δ. The change in pressure is proportional to the volume of injection gas (e.g., the flow rate multiplied by the change in time), i.e., to be able to maintain a certain pressure, p, in the annulus (140), the volume of injection gas needed will be different between a soft liner (e.g., small E, high δ) and a more rigid liner (e.g., high E, small δ). A test may include reaching a specific target pressure in the annulus (140), p-_{Target}, by injecting the injection gas (201) and measuring the total volume of injection gas injected in the annulus (140). The test may provide insights on the modulus retention/degradation of the liner (110) by comparing the response of a new liner vs. an aged liner.

FIG. 5 depicts an example representative model for liner degradation generated in accordance with one or more embodiments. The test result may demonstrate that a time plot of a pressure (e.g., a pressure response), p(t), exerted on the liner (110) may be different for liners having different moduli, such as Young's Modulus, E, which may provide monitoring of the alteration of liner mechanical properties.

The liner deformation (240) may be represented using beam theory (e.g., a structural beam) where the liner (110), fixed at a first fixed point (501) and a second fixed point (502), is modeled as a linear beam of length L that is under a force (504) exerted by a pressure which results in a pressure response, p(t), and undergoes liner deformation δ(x,t) as follows:

$$δ ( x , t ) = \frac{p ( t )}{24 EI} ( {x}^{4} - 2 {Lx}^{3} + {L}^{3} x ) = \frac{p ( t )}{24 EI} H ( x , L ) \qquad ( 2 )$$

where E is the young's modulus, I is the second moment of area which depends on the assumption taken for the beam cross-section, H(x,L) represents the polynomial x⁴-2Lx³+L³x, and δ(x, t) represents the liner deformation (240) along a horizontal axis, x, and over a time, t. Assuming an ideal gas behavior in the annulus (140) having a volume V(t) at temperature T, the pressure response, p(t) can be expressed as:

$$p ( t ) = \frac{n ( t ) RT}{V ( t )} = \frac{{Q}_{n} \times t \times RT}{V ( t )} \qquad ( 3 )$$

where Qₙ denotes the flow rate (264) of the injection gas (201) (e.g., a constant flow rate) expressed in unit of moles per second (mol/s), and R denotes is the universal gas constant.

The injection gas volume V(t) may be expressed as an integral of the beam deflection as follows:

$$V ( t ) = {\int }_{0}^{L} δ ( x ) dxdz = \frac{p ( t )}{EI} G ( L ) , \qquad ( 4 )$$

where G(L) is a constant geometry factor which can be expressed as:

$$G ( L ) = {\int }_{0}^{L} H ( x , L ) dxdz , \qquad ( 5 )$$

In some embodiments, the pressure response can be expressed as:

$$p ( t ) = \sqrt{\frac{I}{G ( L )}} \times \sqrt{{Q}_{n} RT} \times \sqrt{E} \times \sqrt{t} \qquad ( 6 )$$

where Eq. (6) is a multiplication of a geometry-related factor (280) (I/G(L)), a flux-related factor (281) (Qₙ RT), a material related factor (E) and time (t). Eq. (6) demonstrates that at a constant geometry factor (i.e., interrogation on the same location but at different time intervals) and for a given flow rate Qₙ (e.g., a constant temperature during the test), a pressure response, p(t), during the test would vary in square root of time t with a multiplying factor proportional to √E. In other words, the modulus (e.g., the Young's modulus, E) of the liner material has a direct influence on a time plot of pressure, p(t), as shown and described in relation to FIG. 6. In some embodiments, Eq. (6) may be used to determine, using the deformation modeling system (270), the modeled pressure response (276) which may then be compared to the pressure response (271).

In accordance with one or more embodiments, the annulus (140) may initially contain some parked fluids (e.g., permeated fluids from transported fluids during operation) which may contribute to a pressure response, p(t), acting on the liner (110). In some embodiments, parked fluids may be vented to the atmosphere during operation (i.e., initial annulus pressure is approximately zero). Additionally, assuming that the duration of the annulus testing (e.g., from a start time to a stop time, Δt) is less than a liner material's characteristic time of gas diffusion through the liner material, the liner deformation (240) may be based on the volume of injection gas (202) injected during testing. In particular, for embodiments where the initial annulus pressure is non-zero (e.g., non-vented gases), a pressure response, p(t), may be determined based on combining the initial pressure, p₀, in the annulus (140) with the pressure response of the injected gas which may be expressed as follows:

$${p}_{cf} ( t ) = {p}_{0} + \frac{{Q}_{n} \times t \times RT}{V ( t )} , \qquad ( 7 )$$

yielding a pressure correction factor, p_{cf}(t). The pressure correction factor (278) may be substituted in for the pressure response, p(t), to yield a corrected pressure response (283) and in calculating the liner deformation (240) yielding a corrected liner deformation (279).

In some embodiments, a lined unit, such as the lined unit (101), may be in operation and, for example, the pressure response (271), p(t), may be a net pressure response pₙₑₜ(t) of an external pressure, pₑₓₜ, of parked fluid and/or injected gas and an internal pressure, pᵢₙₜ, of the fluid pressure, p_{fl}, as follows:

$$p ( t ) = {p}_{net} ( t ) = max ( {p}_{ext} - {p}_{int} , 0 ) , \qquad ( 8 )$$

therefore, critical collapse condition will occur if Pₙₑₜ>P_{c}. Eq. (2) through (7) may take into account the net pressure response for p(t) to yield an adjusted pressure response (284) and in calculating the liner deformation (240) yielding an adjusted liner deformation (285).

FIG. 6 depicts example pressure responses (e.g., a first pressure response (603), a second pressure response (604), and a third pressure response (605)) that may be generated by the liner monitoring system (100) in accordance with one or more embodiments. An X-axis (601) represents time from the start time (262) to the stop time (263), and a Y-axis (602) represents a pressure response from pressure build-up within the annulus (140) during a test. A test may demonstrate that a modulus of the liner material, (e.g., Young's modulus, b) at the time of the test (e.g., a first test, a first inspection test, and/or a second inspection test with each test separated by a pre-determined length of time) may influence the shape of the pressure build-up over time in the annulus (140) and is shown by the pressure responses (271), p(t). Multiple pressure responses, p(t), may be used to monitor the alteration of a liner material's modulus (e.g., Young's modulus) downwards (e.g., plasticization where E1<E0) or upwards (e.g., hydrolysis, and/or increase in crystallinity where E2>E0) of the liner material during operation. Each inspection test may be compared, using the deformation modeling system (270), to a first test (E₀) obtained at the time of installation on the unaged material.

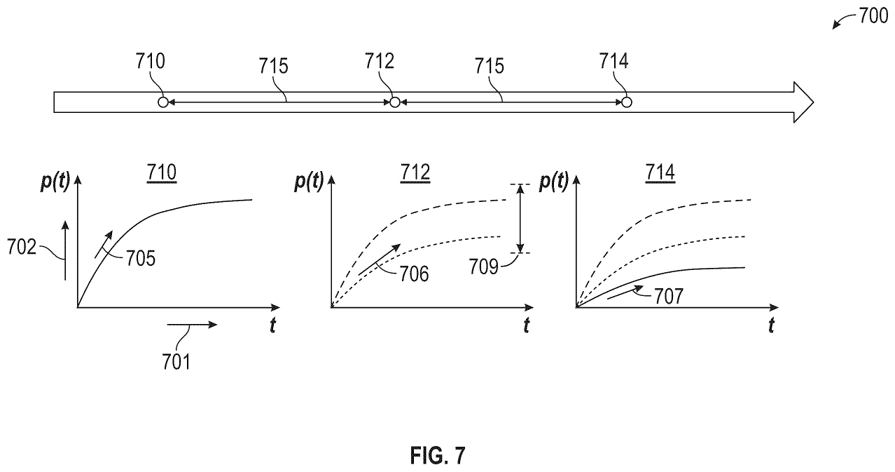

FIG. 7 depicts example results of a test generated by the liner monitoring system (100) in accordance with one or more embodiments. The liner monitoring system (100) is configured to perform one or more tests (e.g., a first test (710), a first inspection test (712), and/or a second inspection test (714)). Each test may be separated by a pre-determined length of time (715) (e.g., a year). In some embodiments, a rate of pressure build-up (277) (i.e., a derivative of p(t) or dp/dt) is also proportional to \sqrt{E}. In other words, a pressure will tend to rise faster for a stiff material compared to softer material, which may be another indication of property alteration (by comparison to a first test). Even though the various pressure responses shown have relative positioning to each other, it will be apparent to those skilled in the art that the pressure curves shown are for example purposes only and each position relative to the others should not be considered limiting.

For example, the first test (710) may be performed along a timeline (700) at a time the liner (110) is installed within the system unit (106) or after a pre-determined length of time. The first inspection test (712) may be performed after a pre-determined length of time (715) (e.g., six months, a year, or other various time periods that may segregate a normal life expectancy of a lined unit into discrete testing periods) after the first test. Each pressure response curve may be plotted with an X-axis (701) representing time from the start time to stop time, and a Y-axis (702) representing pressure build-up during a test (e.g., the first test (710), the first inspection test (712), and/or the second inspection test (714). The second inspection test (714) may be performed after another pre-determined length of time (e.g., six months, a year, or other various time periods that may segregate a normal life expectancy of a lined unit into discrete testing periods).

Each pre-determined length of time may be the same length of time or may be different lengths of time and dependent on operational needs such as, but not limited to, maintenance and/or resources available in accordance with one or more embodiments. Each inspection test's rate of pressure build-up (706, 707) may be compared to a first rate of pressure build-up (705) during the first test (710) as shown in FIG. 7 to yield a test comparison. If the liner (110) is degrading due to age and plasticization, the deformation modeling system (270) may determine that the rate of pressure build-up (277) decreases (or increases for other embodiments) with respect to the first test. For accurate comparisons, certain conditions for testing should be consistent between tests, such as, but not limited to flow rate of the production fluid within the liner (110) and ambient temperature of the environment.

In accordance with one or more embodiments, the liner monitoring system (100) may be configured to compare the first test's pressure response with either a modeled pressure response or with each inspection test's pressure response. The pressure responses may be compared to an integrity threshold range (709). An integrity threshold range may be determined from modeling pressure responses based on an increase in annulus pressure in comparison to the modeled critical collapse pressure as defined, for example, in Eq. (1). In some embodiments, the integrity threshold range (709) may be based on a change in liner integrity over time. If the pressure responses are outside of the integrity threshold range (709), then remediation efforts may be employed to avoid liner failure such as liner collapse.

In some embodiments, the liner monitoring system (100) may be configured to vary, using the flow controller (210), the flow rate (264) in a sinusoidal fashion and determine the liner deformation (240). In some embodiments, sinusoidal variation in the flow rate (264) may be performed after an equilibrium state is reached and described above in relation to FIG. 1. The flow rate (264) of the injection gas (201) can be expressed as:

$${Q}_{V} = {Q}_{V 0} + Δ {Q}_{V} ( t ) = {Q}_{V 0} + Δ {Q}_{0} exp ( ω t ) \qquad ( 9 )$$

The resulting pressure response, p(t), can be expressed as:

$$p ( t ) = {p}_{0} + Δ p ( t ) = {p}_{0} + Δ {p}_{0} exp ( ω t + τ ) \qquad ( 10 )$$

where τ is the phase lag between the load and the response of the material and is related to the viscoelastic properties of the material.

In some embodiments, the liner monitoring system (100) may be configured to vary the flow rate (264), using the flow controller (210), in a sweep fashion. A test can be carried out with the flow rate (264) at different frequencies (ω), i.e., performing a frequency sweep and the plot of storage and loss moduli can then be used to derive various quantities such as a viscoelastic modulus. In some embodiments, a prediction of long-term properties of the liner material using time-temperature superposition principles may be based on natural temperature fluctuations that occur between day and night.

In some embodiments, the liner monitoring system (100) may be configured to determine the liner deformation (240) in a three-dimensional (“3-D”) model space. The deformation modeling system (270) may be configured to generate a finite-element model of the system unit (106) and liner (110). The finite element model may model or simulate the pressure response (271) of the liner (110) to the injection of the injection gas (201) in 3-D model space. In some embodiments, the finite element model may take the form of a finite element model, finite difference model, or finite volume model. The finite element model may include structural/geometrical, mechanical, boundary condition, and/or mesh information. In some embodiments, the deformation modeling system (270) may be configured to generate the finite element model. The deformation modeling system (270) may take the form of software located on a memory of a computer system.

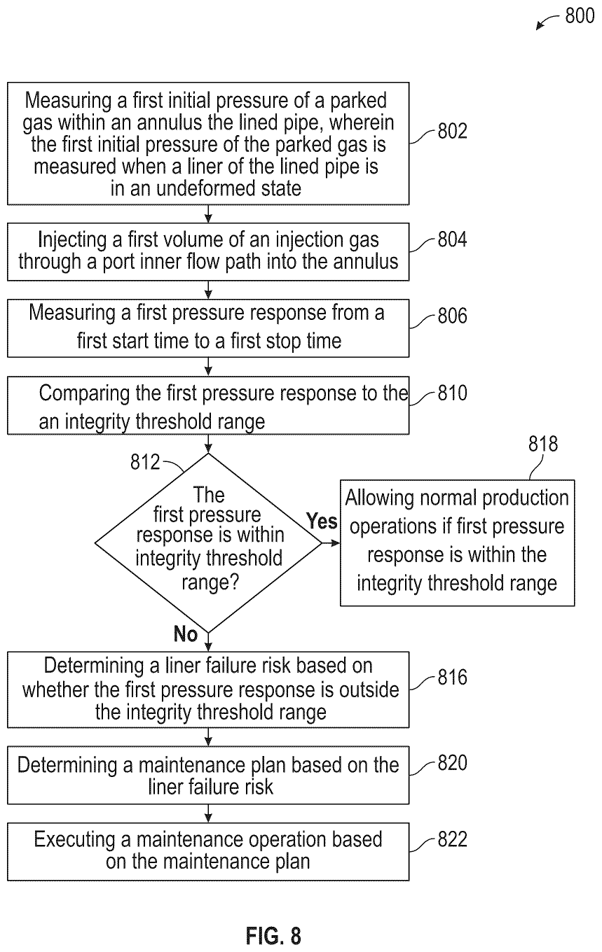

FIG. 8 depicts a flowchart in accordance with one or more embodiments describing a method for monitoring lined units (hereafter “liner monitoring method” (800)). In some embodiments, the liner monitoring method (800) may use the liner monitoring system (100). Although the steps in flowchart using the liner monitoring method (800) are shown in sequential order, it will be apparent to one of ordinary skill in the art that some steps may be conducted in parallel, in a different order than shown, or may be omitted without departing form the scope of the invention.

In some embodiments, the liner monitoring method (800) may include deploying a liner monitoring system (100) in accordance with one or more embodiments. The inlet port (120) may be disposed on the system unit (106) so that the port inner flow path (125) abuts the liner (110). In some embodiments, the inlet port (120) may be disposed on a lined unit that is newly formed. In some embodiments, the liner (110) and the inlet port (120) may be disposed on an existing system unit of an existing pipeline.

In box (802), the liner monitoring method (800) includes measuring, using the first pressure gauge (220) disposed on the flow line (230), an initial pressure (261), p₀, (e.g., a first initial pressure and/or a second initial pressure) of the parked fluid (211) within the annulus (140) of the lined unit in accordance with one or more embodiments. The first initial pressure may be measured at the start time (262) (e.g., the first start time and/or the second start time). In some embodiments, the first initial pressure, p₀, of the parked fluid (211) is measured when the liner (110) is in the undeformed state (242).

In some embodiments, the liner monitoring method (800) may include recording a start time (262), (e.g., a first start time and/or a second start time) in accordance with one or more embodiments. The control system (260) may be configured to record the start time (262) using a timing device such as a clock. The start time (262) may be recorded on a memory of a computer system such as computer system (900) as described in relation to FIG. 9.

In box (804), the liner monitoring method (800) includes injecting, using the gas tank (200), a volume of injection gas (202) (e.g., a first volume and a second volume) through the port inner flow path (125) into the annulus (140) in accordance with one or more embodiments. The gas tank (200) is fluidly connected to the inlet port (120) via the flow line (230).

In box (806), the liner monitoring method (800) includes measuring, using the first pressure gauge (220), the pressure response (271) (e.g., the first pressure response (603)) between the start time (262) (e.g., the first start time and/or the second start time) and the stop time (263) (e.g., a first stop time and/or a second stop time) in accordance with one or more embodiments. In some embodiments, the liner monitoring method (800) may include recording the stop time (263). The control system (260) may be configured to record the stop time (263) using a timing device such as a clock. Each stop time (263) may be recorded on a computer memory such as the memory as described in relation to FIG. 9. The timing device is operatively connected to the control system (260).

In box (810), the liner monitoring method (800) includes comparing the pressure responses (271) (e.g., the first pressure response (603) and/or the second pressure response (604)) to the integrity threshold range (709). For example, the first pressure response (603) may be compared to a modeled pressure response and the second pressure response (604) response may be compared to the first pressure response (603). A test comparison may include differencing the different response curves and comparing the difference to the integrity threshold range (709). In some embodiments, a test comparison may include comparing the difference in the rates of pressure build-ups.

In some embodiments, the liner monitoring method (800) may include calculating, using the deformation modeling system (270), the liner deformation (240) (e.g., a first liner deformation and/or a second liner deformation) from the start time (262) to the stop time (263) in accordance with one or more embodiments. For example, the first liner deformation may be calculated from the first start time to the first stop time yielding the first test (710). For another example, the second liner deformation may be calculated from the second start time to the second stop time yielding the inspection test (e.g., the first inspection test (712), and/or the second inspection test (714). Calculating the liner deformation (240) may include calculating the liner deformation (240) according to Eq. (2) as described in relation to FIG. 2A to FIG. 2B. In some embodiments, calculating the liner deformation (240) may include calculating the slope of the pressure build-up or the rate of pressure build-up (277) and qualitatively comparing each test (e.g., the first test (710), the first inspection test (712), the second inspection test (714)) to determine the liner deformation (240).

In box (812), the liner monitoring method (800) includes determining, using the deformation modeling system (270), if the pressure response (271) and/or the liner deformation (240) (e.g., a first liner deformation and/or a second liner deformation) is outside the integrity threshold range (709) and/or the deformation threshold range (272), respectively, in accordance with one or more embodiments. The integrity threshold range (709) and/or the deformation threshold range (272) may be input using the user device (255).

In box (816), the liner monitoring method (800) includes determining the liner failure risk (274) based on whether the pressure response (271) and/or the liner deformation (240) is outside the integrity threshold range and/or the deformation threshold range (272), respectively, in accordance with one or more embodiments.

In some embodiments, determining that the pressure response (271) and/or the liner deformation (240) is outside the integrity threshold range (709) and/or the deformation threshold range (272), respectively, may include determining that the pressure response (271) and/or the liner deformation (240) is less than the integrity threshold range (709) and/or the deformation threshold range (272), respectively. Liner degradation may include liner plasticization if the pressure response (271) and/or the liner deformation (240) is less than the integrity threshold range (709) and/or the deformation threshold range (272), respectively. In some embodiments, determining that the pressure response (271) and/or the liner deformation (240) is outside the integrity threshold range (709) and/or the deformation threshold range (272), respectively, may include determining that the pressure response (271) and/or the liner deformation (240) is greater than the integrity threshold range (709) and/or the deformation threshold range (272), respectively. Liner degradation may include liner brittleness if the pressure response (271) and/or the liner deformation (240) is greater than the integrity threshold range (709) and/or the deformation threshold range (272), respectively.

In some embodiments, the liner monitoring method (800) may include determining the liner failure risk (274) based on whether the pressure response (271) and/or the liner deformation (240) (e.g., the first liner deformation) is outside the integrity threshold range (709) and/or the deformation threshold range (272), respectively, in accordance with one or more embodiments. In box (818), the liner monitoring method (800) may include allowing normal production operations based on whether the pressure response (271) and/or the liner deformation (240) is within the integrity threshold range (709) and/or the deformation threshold range (272), respectively. Normal operations may include flowing a production fluid (e.g., oil and/or gas) through the system unit (106) and the liner (110) along the production flow path (130).

In box (820), the liner monitoring method (800) includes determining the maintenance plan (290) based on the liner failure risk (274) in accordance with one or more embodiments. The deformation modeling system (270) may be configured to determine the maintenance plan (290) based on the liner failure risk (274).

In box (822), the liner monitoring method (800) includes executing a maintenance operation (295) based on the maintenance plan (290) in accordance with one or more embodiments. In some embodiments, executing the maintenance operation (295) may include replacing the liner (110) with a new liner. In some embodiments, executing the maintenance operation (295) may include replacing the liner (110) and the system unit (106) with a new liner and a new system unit.

In some embodiments, the liner monitoring method (800) may include adjusting, using the flow controller (210) disposed on the flow line (230), the flow rate (264) of the injection gas (201) to a constant flow rate. In some embodiments, the liner monitoring method (800) may include adjusting, using the flow controller (210) disposed on the flow line (230), the flow rate (264) of the injection gas (201) to a sinusoidal flow rate. In some embodiments, the liner monitoring method (800) may include adjusting, using the flow controller (210) disposed on the flow line (230), the flow rate (264) of the injection gas (201) to a sweep flow rate.

In some embodiments, the liner monitoring method (800) may include determining the injection pressure (265). The injection pressure (265) may include a measured pressure of the injection gas (201) in a range having a lower limit of a pressure associated with elastic deformation of the liner (110) and having an upper limit of a pressure associated with the critical collapse pressure (275) of the liner (110).

In some embodiments, the liner monitoring method (800) may include, when the first initial pressure of the injection gas (201) is greater than zero, applying the pressure correction factor (278) to the liner deformation (240) (e.g., the first liner deformation and/or the second liner deformation) yielding the corrected liner deformation (279). Applying the pressure correction factor (278) may include using the pressure correction factor (278) as the pressure response (271) in Eq. (2) in order to calculate the corrected liner deformation (279).

In some embodiments, the liner monitoring method (800) may include collecting, using the collection tank (250) fluidly connected to the annulus (140) via the vent hose (251), at least a portion of the volume of injection gas (202) (e.g., the first volume and/or the second volume) from the annulus (140) yielding a volume of collected fluid. In some embodiments, the volume of collected fluid may include at least a portion of parked fluids.

In some embodiments, the liner monitoring method (800) may include measuring, using the first pressure gauge (220) disposed on the flow line (230), the second initial pressure of the parked fluid within the annulus (140). The second initial pressure of the parked fluid is measured when the liner (110) is in the undeformed state (242). The liner monitoring method (800) may include recording the second start time. The liner monitoring method (800) may include injecting, using the gas tank (200), a second volume of injection gas through the port inner flow path (125) following the pre-determined length of time (715) after the first test (710). The liner monitoring method (800) may include measuring, using the first pressure gauge (220), a second pressure response between the second start time and the second stop time and recording the second stop time. The liner monitoring method (800) may include calculating a second liner deformation from the second start time to the second stop time yielding the inspection test (e.g., the first inspection test (712) and/or the second inspection test (714)).

In some embodiments, the liner monitoring method (800) may include comparing the second pressure response (604) and/or the second liner deformation to the integrity threshold range (709) and/or the deformation threshold range (272), respectively. The liner monitoring method (800) may include determining the liner failure risk (274) based on whether the second pressure response (604) and/or the second liner deformation is outside integrity threshold range (709) and/or the deformation threshold range (272), respectively. The liner monitoring method (800) may include determining the maintenance plan (290) based on the liner failure risk (274). The liner monitoring method (800) may include executing the maintenance operation (295) based on the maintenance plan (290). The liner monitoring method (800) may include determining the liner thickness (113).

In some embodiments, the liner monitoring method (800) may include, using the deformation modeling system, determining automatically a geometry-related factor and/or a flux-related factor such as the geometry-related factor (280) and/or the flux-related factor (281) defined in relation to Eq. (6). The liner monitoring method (800) may include determining automatically the modeled pressure response (276). The liner monitoring method (800) may include comparing automatically the modeled pressure response (276) to the pressure response (271).

In some embodiments, the liner monitoring method (800) may include comparing the liner thickness (113) to the thickness threshold (273) yielding a thickness comparison. The liner monitoring method (800) may include determining the liner failure risk (274) based on the thickness comparison. The liner monitoring method (800) may include determining the maintenance plan (290) based on the liner thickness (113). The liner monitoring method (800) may include executing the maintenance operation (295) based on the maintenance plan (290).

The ideal situation is to stop flow and evacuate the containment area prior to testing (atmospheric pressure inside flow or containment area of pipe or tank). However, as this is not always possible, by measuring the internal pressure of the containment/production fluid area, such as the production flow path (130), and using a net pressure, such as pₙₑₜ defined in Eq. (8), a similar analysis and determination of liner integrity may be made based on the net pressure—so while describing the calculations of the pressure response, p(t), with respect to the measured set as outlined, a similar analysis breakdown can be made for an adjusted set of one or more pressure measurements (282) and/or pressure responses such as in Eq. (10). In some embodiments, the liner monitoring method (800) may include measuring, using one of the pressure sensing devices, the fluid pressure (266) within the production flow path (130) of the lined unit (101).

In some embodiments, the liner monitoring method (800) may include adjusting, using the deformation modeling system (270), the set (e.g., the first set and/or the second set) of one or more pressure measurements (e.g., the initial pressure (261) and/or the injection pressure (265)) within the annulus (140) based on the fluid pressure (266) to provide the adjusted set of one or more pressure measurements (282). In some embodiments, the liner monitoring method (800) may include determining, using the deformation modeling system (270), the adjusted pressure response (284) based on the adjusted set of one or more pressure measurements (282). In some embodiments, the liner monitoring method (800) may include determining, using the deformation modeling system (270), the adjusted liner deformation (285) based on the adjusted set of one or more pressure measurements (282).

FIG. 9 further depicts a block diagram of a computer system (902) used to provide computational functionalities associated with described algorithms, methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902), and any algorithms, methods, functions, processes, flows, and procedures as described in the instant disclosure.

The computer (902) also includes a memory (906) that holds data for the computer (902) or other components (or a combination of both) that can be connected to the network (930). The memory may be a non-transitory computer readable medium. For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Embodiments disclosed herein may include at least one of the following advantages. The disclosed invention may improve the reliability and confidence in lined units such as lined pipes, for example, polymer lined pipe (PLP) for rehabilitation of corroded carbon steel pipelines. The disclosed invention may provide potential liner collapse detection in lined units due to accumulation of fluids between a liner and host pipe. For example, methods disclosed herein provide methods for unveiling possible degradation in mechanical properties of a liner to anticipate failure/collapse, and a cost-effective solution for non-destructive testing and structural health monitoring of liners such as thermoplastic liners. Methods and systems disclosed herein may provide early-stage detection of liner degradation, in a pragmatic and cost-effective way that can help avoid costly maintenance and production shutdowns. Whether the degradation of a liner is reversible or permanent, the disclosed invention of the present application provides systems and methods for monitoring loss of mechanical properties of a liner while in operation, particularly modulus, to mitigate any failure risk such as liner collapse.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for monitoring integrity of liners of lined units for storing or transporting fluids, comprising:
a flow line configured to facilitate a gas flow;
a gas tank configured to inject a first volume of an injection gas through the flow line into an annulus of the lined unit;
a flow controller disposed on the flow line and configured to adjust a flow rate of the injection gas into the annulus;
a pressure gauge disposed on the flow line and configured to measure a first set of one or more pressure measurements within the annulus of the lined unit measured from a first start time to a first stop time; and
a deformation modeling system configured to determine a first pressure response based on the first set of one or more pressure measurements from the pressure gauge.

2. The system of claim 1, wherein the deformation modeling system is further configured to:
compare the first pressure response to an integrity threshold range;
determine a liner failure risk based on whether the first pressure response is outside the integrity threshold range; and
determine a maintenance plan based on the liner failure risk.

3. The system of claim 1, wherein the deformation modeling system is further configured to automatically:
determine a geometry-related factor;
determine a modeled pressure response; and
compare the modeled pressure response to the first pressure response.

4. The system of claim 1, further comprising the flow controller disposed on the flow line and configured to adjust the flow rate of the injection gas to a constant flow rate.

5. The system of claim 1, further comprising the flow controller disposed on the flow line and configured to adjust the flow rate of the injection gas to a sinusoidal flow rate.

6. The system of claim 1, wherein the deformation modeling system is further configured to:
calculate automatically a liner deformation from the first start time to the first stop time based on the first pressure response;
compare the liner deformation to a deformation threshold range;
determine a liner failure risk based on whether the liner deformation is outside the deformation threshold range; and
determine a maintenance plan based on the liner failure risk.

7. The system of claim 1, further comprising a second pressure gauge operatively connected to the lined unit and configured to measure a fluid pressure within a production flow path of the lined unit, wherein the deformation modeling system is further configured to:
adjust the first set of one or more pressure measurements within the annulus based on the pressure of the fluid to provide an adjusted set of one or more pressure measurements, and
determine the first pressure response based on the adjusted set of one or more pressure measurements.

8. A method for monitoring integrity of liners of lined units for storing or transporting fluids, comprising:
measuring a first initial pressure of a parked fluid within an annulus of a lined unit, wherein the first initial pressure of the parked fluid is measured when a liner of the lined unit is in an undeformed state;
injecting a first volume of an injection gas into the annulus to deform the liner; and
measuring a first pressure response from a first start time to a first stop time yielding a first test,
wherein the first pressure response comprises a first set of one or more pressure measurements measured between the first start time to the first stop time.

9. The method of claim 8, further comprising:
comparing the first pressure response to an integrity threshold range;
determining a liner failure risk based on whether the first pressure response is outside the integrity threshold range;
determining a maintenance plan based on the liner failure risk; and
executing, using a maintenance system, a maintenance operation based on the maintenance plan.

10. The method of claim 8, further comprising:
comparing the first pressure response to an integrity threshold range; and
allowing normal production operations based on whether the first pressure response is within the integrity threshold range.

11. The method of claim 8, further comprising determining an injection pressure, wherein the injection pressure comprises a measured pressure of the injection gas in a range having a lower limit of a pressure associated with elastic deformation of the liner and having an upper limit of a pressure associated with a critical collapse pressure of the liner.

12. The method of claim 8, further comprising, when the first initial pressure of the injection gas is greater than zero, applying a pressure correction factor to the first pressure response yielding a corrected pressure response.

13. The method of claim 8, further comprising adjusting a flow rate of the injection gas to a constant flow rate.

14. The method of claim 8, further comprising:
adjusting a flow rate of the injection gas to a sinusoidal flow rate.

15. The method of claim 8, further comprising:
determining a geometry-related factor;
determining a modeled pressure response; and
comparing the modeled pressure response to the first pressure response.

16. The method of claim 8, further comprising:
measuring a second initial pressure of the parked fluid within the annulus, wherein the second initial pressure of the parked fluid is measured when the liner is in the undeformed state following a pre-determined length of time after the first test;
injecting a second volume of the injection gas into the annulus to deform the liner;
measuring a second pressure response from a second start time to a second stop time,
wherein the second pressure response comprises a second set of one or more pressure measurements measured between the second start time to the second stop time; and
comparing the second pressure response to the first pressure response yielding a test comparison.

17. The method of claim 16, further comprising:
comparing the test comparison to an integrity threshold range;
determining a liner failure risk based on whether the test comparison is outside the integrity threshold range;
determining a maintenance plan based on the liner failure risk; and
executing a maintenance operation based on the maintenance plan.

18. The method of claim 8, further comprising:
determining a liner thickness;
comparing the liner thickness to a thickness threshold yielding a thickness comparison;
determining a liner failure risk based on the thickness comparison;
determining a maintenance plan based on the liner thickness; and
executing a maintenance operation based on the maintenance plan.

19. The method of claim 8, further comprising:
calculating automatically a liner deformation from the first start time to the first stop time based on the first pressure response;
comparing the liner deformation to a deformation threshold range;
determining a liner failure risk based on whether the liner deformation is outside the deformation threshold range; and
determining a maintenance plan based on the liner failure risk.

20. The method of claim 8, further comprising:
measuring a fluid pressure within a production flow path of the lined unit;
adjusting the first set of one or more pressure measurements within the annulus based on the pressure of the fluid to provide an adjusted set of one or more pressure measurements; and
determining the first pressure response based on the adjusted set of one or more pressure measurements.
